(19) United States
(12) Patent Application Publication
(10) Pub. No.: US 2017/0279947 A1
(43) Pub. Date: Sep. 28, 2017

(54) Hybrid Telematics Enhancements With In-Vehicle Mobile Devices And Smart Sensors

(71) Applicant: MediaTek Inc., Hsinchu City (TW)

(72) Inventors: Yasantha Rajakarunanayake, San Ramon, CA (US); Gaurav Arora, Cupertino, CA (US)

(21) Appl. No.: 15/620,864

(22) Filed: Jun. 13, 2017

(51) Int. Cl. H04M 1/60; H04W 12/06; H04W 4/02; G06F 9/50; H04W 8/22; H04W 76/02

(52) U.S. Cl. CPC H04M 1/6091; H04W 8/22; H04W 76/02; H04W 4/02; G06F 9/50; H04W 12/06

(57) ABSTRACT

Apparatus and methods are described for a telematics system for a vehicle. The vehicle telematics system identifies available computing resources of a mobile device. The vehicle telematics system identifies a task of the telematics system that can be performed by the identified available computing resources of the mobile device and dispatches the identified task to the mobile device to be performed.

### TECHNICAL FIELD

The present disclosure is generally related to vehicle telematics.

### BACKGROUND

Unless otherwise indicated herein, approaches described in this section are not prior art to the claims listed below and are not admitted to be prior art by inclusion in this section.

Telematics is convergence of telecommunications and information processing, specifically referring to automation in automobiles. Examples of vehicle telematics include emergency warning system for vehicles, global positioning system (GPS) navigation, integrated hands-free cell phones, wireless safety communications, and automatic driving assistance systems (ADAS).

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the present disclosure provide a telematics system for a vehicle. The vehicle telematics system identifies available computing resources of a mobile device. The vehicle telematics system identifies a task of the telematics system that can be performed by the identified available computing resources of the mobile device and dispatches the identified task to the mobile device such that the identified task is performed by the identified available computing resource of the mobile device.

In some embodiments, the vehicle telematics system allows a mobile device to join the telematics system and receives a first set of sensor data from a built-in sensor of the vehicle and a second set of sensor data from the mobile device. The vehicle telematics system generates a set of fused sensor data based on the first and second set of sensor data and provides a telematics application for the vehicle based on the set of fused sensor data.

Some embodiments of the present disclosure provide an electronic apparatus for providing a hybrid telematics system in a vehicle. The electronic apparatus includes a wired communications interface, a sensor interface and one or more processors. The wired communications interface can communicate with at least a first mobile device through a wired communications medium. The sensor interface can receive data from one or more built-in sensors of a vehicle. The one or more processors can provide telematics applications for the vehicle by dispatching one or more tasks to be performed at computing resources of the first mobile device over the wired communications interface and by fusing sensor data provided by the first mobile device with sensor data provided by the one or more built-in sensors.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 illustrates a vehicle that is equipped with a hybrid vehicle telematics system in accordance with the present disclosure.

FIG. 2 illustrates different types of sensor data in a hybrid telematics system of a vehicle in accordance with the present disclosure.

FIG. 3 conceptually illustrates a process for operating a hybrid vehicle telematics system in accordance with the present disclosure.

FIG. 4 illustrates a block diagram of the vehicle computation hub in accordance with the present disclosure.

FIG. 5 illustrates the hybrid vehicle telematics system improving sensor data accuracy and SNR by fusing sensor data from one or more mobile devices with sensor data from one or more built-in sensors of the vehicle in accordance with the present disclosure.

FIG. 6 illustrates the hybrid vehicle telematics system improving GPS accuracy by incorporating additional GPS signals from different GPS sources received by mobile devices in accordance with the present disclosure.

FIG. 7 illustrates the hybrid vehicle telematics system dispatching tasks to the one or more mobile devices linked into the vehicle computation hub in accordance with the present disclosure.

FIG. 8 conceptually illustrates a process for dispatching tasks to one or more mobile devices in a hybrid vehicle telematics system in accordance with the present disclosure.

FIG. 9 illustrates the hybrid vehicle telematics system using the computing resources of the one or more mobile devices to create a computing layer between the cloud and the vehicle's built-in systems in accordance with the present disclosure.

FIG. 10 conceptually illustrates processes for operating a hybrid telematics system in accordance with the present disclosure.

FIG. 11 conceptually illustrates an electronic system in which some embodiments of the present disclosure may be implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

Global positioning system (GPS) and global navigation satellite system (GNSS) technologies provide absolute location for automotive navigation and location aware applications, as well as pedestrian navigation and location. Automobiles are expected to have these capabilities available, even when GPS is unavailable due to poor signal strength or is unreachable. This requires inertial navigation based estimation and automotive dead reckoning (ADR). Sensors such as gyroscopes are needed for inertial navigation but may not be built-into the automobile. However, these sensors are often readily available in one or more mobile devices that are brought on to the vehicle by its occupants.

Some embodiments of the present disclosure provide a hybrid vehicle telematics system capable of using computing and sensory resources in mobile devices (e.g., smartphones or smart wearables) present within a vehicle to provide improved location data and telematics. The system is a hybrid system capable of combining data from, for example, mobile devices, engine control unit (ECU), and one or more built-in sensors of the car to enhance the vehicle's automated driver assisted systems (ADAS) and/or telematics systems.

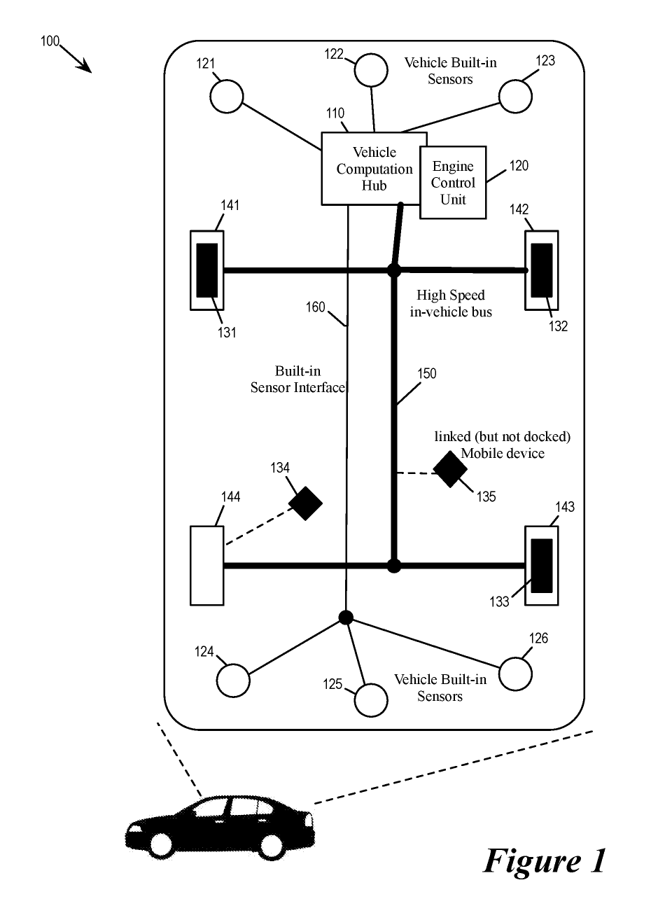

FIG. 1 illustrates a vehicle 100 that is equipped with a hybrid vehicle telematics system. The vehicle 100 is equipped with an ECU 120 and a set of built-in sensors 121-126. The vehicle is carrying aboard several mobile devices 131-135. The vehicle has a computation hub 110 capable of receiving sensor data from the built-in sensors 121-126, the ECU 120, and communicating with the mobile devices 131-135 in order to provide enhanced telematics for the vehicle 100.

The vehicle computation hub 110 can be the computing center of the vehicle. It is capable of performing computation based on received sensor data and/or ECU data in order to provide telematics information and/or services to the user. Vehicle telematics generally refers to automation in automobiles, such as GPS navigation, integrated hands-free cell phones, wireless safety communications, emergency warning systems, and ADAS.

The built-in sensors 121-126 may be fixtures provided by the manufacturer of the vehicle. They may provide various sensor data to the vehicle computation hub 110, data such as GPS data, speed data, acceleration data, braking data, proximity data, and other types of data or measurements that are used by the vehicle computation hub 110 to provide telematics to the vehicle's users.

The ECU 120 is an electronic control unit capable of controlling a series of actuators on the vehicle's engine to ensure optimal engine performance. The ECU may generate these controls based on status of the engine, various sensor data of the vehicle, as well as direct inputs by the driver (steering wheel, gas pedal, brake, control settings, etc.) In some embodiments, the ECU 120 may be integrated with the vehicle computation hub 110 such that the data used by the ECU and data generated by the ECU may be available to the vehicle computation hub 110 for providing telematics. For some embodiments, the computing device that serves as the ECU of the vehicle may also serve as the vehicle's computation hub.

Mobile devices 131-135 may be devices brought on board the vehicle by the driver or the passengers of the vehicle. They may not be fixtures of the vehicle and may generally not be provided by the vehicle's manufacturer. Their capabilities are not limited by the original manufacturing of the vehicle, but instead may reflect the state of the art of the mobile devices.

A mobile device can be a smartphone, a smart wearable (smart watch, smart bracelet, smart necklace, etc.) a tablet computer, a laptop computer, or another type of computing devices that can be easily carried on board the vehicle by its user and capable of communication with the vehicle's telematics system. Each mobile device may have one or more types of sensors—e.g., magnetometer, gyroscope and accelerometer. These sensors assist in prediction of the estimated position and/or status of the vehicle. Each mobile device may have additional sensor, communications capabilities and computing resource that can augment the capability of the vehicle, capabilities such as cell tower locationing, Wi-Fi indoor locationing, barometric and temperature of the ambient, etc. Mobile devices may also have specialized apps that provide additional communications capabilities, such as cloud-based apps, Al-based apps, peer-to-peer-based apps, etc.

In some embodiments, a mobile device can be docked into the vehicle computation hub 110 through an in-vehicle bus at a docking port. A docking port can be a fixture of the vehicle that is capable of providing charging as well as steady (fixed to interior frame of the car) physical support to a mobile device that is physically docked. This allows sensors such as accelerometers, gyroscopes, and magnetometers to be predictably and usefully oriented. For example, some mobile devices may provide 3-axis magnetic heading, and the docking ports may be positioned within the vehicle so that the docked mobile devices would be placed away from static ferro-magnetic or paramagnetic interferences and materials. A docking port may also be a physical cable that is not fixed to any particular position of the vehicle. However, in some embodiments, one or more of the mobile devices may not be physically docked. The non-docked mobile device may communicate with the vehicle computation hub 110 and/or the ECU 120 by wired or wireless connection.

FIG. 1 illustrates an in-vehicle bus 150 for connecting one or more mobile devices to the vehicle computation hub 110. The in-vehicle bus 150 can be a high-speed in-vehicle bus connected to docking ports 141-144. Each of the docking ports may be at a fixed location of the vehicle 100 such that a mobile device physically docked with a docking port may have a fixed position at a known fixed orientation within the vehicle. The vehicle computation hub 110 and/or the ECU 120 may also be connected to the built-in sensors 121-126 through a sensor interface 160 for receiving sensor data.

As illustrated, the mobile device 131 can be physically docked at the docking port 141, the mobile device 132 can be physically docked at the docking port 142, and the mobile device 133 can be physically docked at the docking port 143. The vehicle computation hub 110 and/or the ECU 120 may therefore be able to communicate directly with the mobile devices 131-133 through the in-vehicle bus 150. Furthermore, the exact position and orientation of the mobile devices 131-133 may be fixed because they are physically docked. In this example, no mobile device is physically docked at the docking port 144. The mobile device 134 and the mobile device 135 may not be physically docked at any of the docking ports, but they may be communicatively linked (e.g., wirelessly docked) with the vehicle computation hub 110 and/or ECU 120. They may not have fixed orientation or position within the vehicle.

Docking with the in-vehicle bus can use either wireless or wired communications technology. Some embodiments may assign each mobile device docked with the in-vehicle bus (thus communicatively connecting to or otherwise joining the telematics network of the vehicle) a Layer-2 MAC address for conducting Ethernet like communications. In the example of FIG. 1, the in-vehicle bus can employ Ethernet like communications in which each of the docked mobile devices (131-135) is assigned a L2 MAC address.

The system in some embodiments requires that the mobile devices docking with the vehicle computation hub and/or ECU to be trusted entities. The owner or family members of the owner can opt to use their mobile devices for communicatively connecting to the vehicle computation hub and/or ECU and joining the vehicle's telematics system.

In some embodiments, an app from the auto manufacturer installed on a mobile device provides the root certificate that authenticates the mobile device with the vehicle. The mobile device can pair with the vehicle (e.g., in a manner similar to how Bluetooth headset gets paired). Once paired, the mobile device may have access to resources in the vehicle (such as media playback by using the built-in speakers and displays of the vehicle), and the vehicle's hybrid telematics system may have access to the sensory, computing and/or networking resources in the mobile device.

For each mobile device that pair with the vehicle computation hub and/or ECU, the hybrid vehicle telematics system may exchange information with the mobile device and identifies the sensory, computing, and/or networking resources available at the mobile device. Depending on the capability of the identified sensory, computing and/or networking resources of the mobile device, the vehicle computation hub and/or ECU may identify the one or more sensors in the mobile device that it needs. The vehicle computation hub and/or ECU may also identify jobs (e.g., machine learning inference) that it can delegate to the computing and/or networking resources of the mobile device.

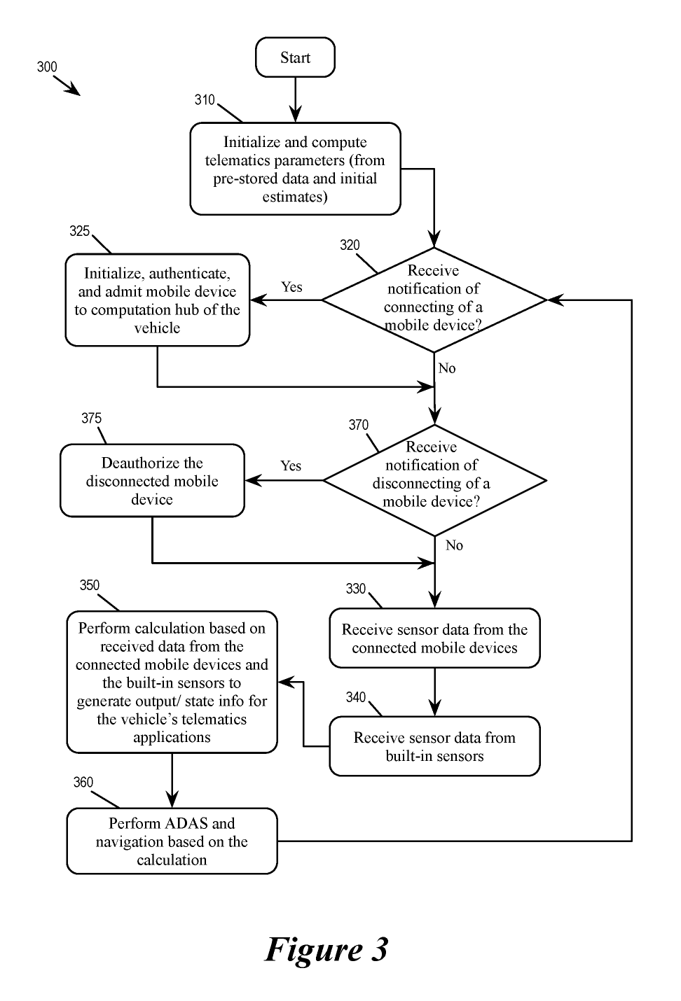

The docking and de-docking of mobile devices will be further described below by reference to FIG. 3.

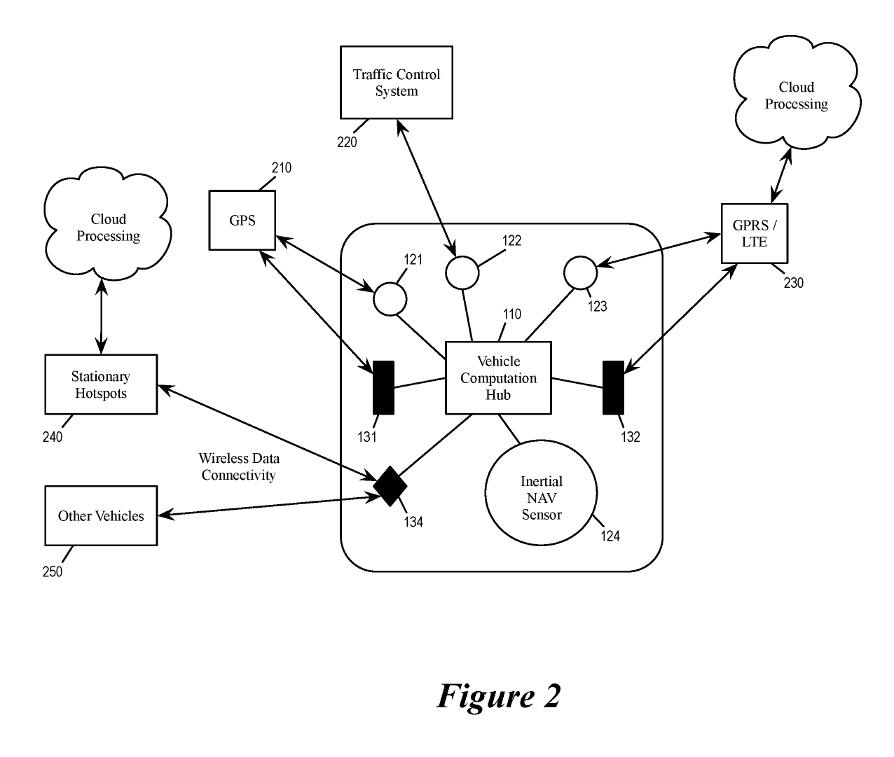

FIG. 2 illustrates different types of sensor data in a hybrid telematics system of a vehicle. These sensor data are from one or more built-in sensors of the vehicle and/or from mobile devices that are carried aboard the vehicle. The figures show various sensor data provided by the built-in sensors 121-124 and the mobile devices 131-134. The vehicle computation hub 110 may receive the data provided by the built-in sensors 121-124 and the mobile devices 131-134 to provide the enhanced telematics for the vehicle.

The built-in sensor 121 may be a GPS sensor that receives GPS data from a GPS source 210 (e.g., satellite or surface stations), the built-in sensor 122 may be a traffic information receiver that receives traffic information (e.g., wirelessly) from a traffic control system 220, the built-in sensor 123 may be a cellular data receiver that receives data from a cellular phone network 230 (e.g., GPRS/LTE). The cellular phone network 230 may also provide access to the Internet and/or cloud-computing resources. The built-in sensor 124 may be a set of inertial navigation sensors that may include magnetometer, gyroscope, and accelerometer.

In some embodiments, the hybrid vehicle telematics system may use the communications and cloud-based app-infrastructure access capabilities of the mobile devices to obtain information such as maps, traffic, and weather from over the Internet or the cloud. The obtained information can be real-time information. In some embodiments, the system may use peer-to-peer and/or peer-to-infrastructure communications components provided by mobile devices.

As illustrated in FIG. 2, the mobile device 131 is equipped with GPS capability and is also receiving GPS data from the GPS source 210. The vehicle's hybrid telematics system therefore has at least two GPS sensors producing two different sets of GPS data from two different spatial positions within the vehicle.

The mobile device 132 may be a smartphone that receives cellular data from the cellular network 230. The mobile device 134 may be capable of wireless data connectivity through protocols such as Wi-Fi or Bluetooth. It can access the Internet or the cloud through stationary hotspots 240. (The vehicle's hybrid telematics system therefore may have three communications channels to access the Internet.)

The mobile device 134 may also be capable of peer-to-peer wireless connection with other vehicles 250. The telematics system of the vehicle 100 can therefore use the peer-to-peer connection to communicate with the other vehicle 250.

FIG. 3 conceptually illustrates a process 300 for operating a hybrid vehicle telematics system. In some embodiments, the vehicle computation hub 110 and/or the ECU 120 may perform the process 300 when it integrates data from one or more built-in sensors and one or more mobile devices. In some embodiments, a set of processing units of a computing device serving as the vehicle computation hub may perform the process 300.

The process 300 starts when it initializes (at step 310) the telematics parameters of the vehicle. These parameters may relate to GPS navigation, integrated hands-free cell phones, wireless safety communications, emergency warning systems, ADAS systems, or other telematics applications operating at the vehicle.

Next, the process 300 determines (at step 320) whether it has received notification of a mobile device connecting with the vehicle computation hub. This notification can be that of a mobile device physically docking at a fixed position docking port connected with the in-vehicle bus, or of a mobile device wirelessly linking with the vehicle computation hub 110 and/or the ECU 120. If there is notification of a mobile device connecting with the vehicle computation hub and/or the ECU, the process 300 proceeds to step 325. Otherwise, the process 300 proceeds to step 370.

At step 325, the process 300 initializes, authenticates, and admits the connected mobile device to the hybrid telematics system of the vehicle. The vehicle computation hub and/or ECU may perform authentication and pair with the connected mobile device in order to ensure that the mobile device is a trusted entity. The vehicle computation hub and/or ECU may also exchange information from the connected mobile device in order to identify and determine the capabilities available in the mobile device. Such information in some embodiments may include central processing unit (CPU) and/or graphics processing unit (GPU) (hereinafter the term “processor” is interchangeably used to refer to CPU and/or GPU) performance metric, storage capacity, Internet access bandwidth, peer-to-peer communications capabilities, GPS capabilities, gyroscope, magnetometer, voice recognition capability, image processing capability, display capability (e.g., screen size), or other information regarding the sensory, computing and networking resources of the mobile device. This allows the vehicle computation hub and/or ECU to receive data from the connected mobile device. This also allows the vehicle computation hub and/or ECU to use the resources available in the connected mobile device. The process then proceeds to 370.

At step 370, the process determines whether it has received notification of a mobile device disconnecting from the vehicle computation hub and/or ECU, i.e., detaching a mobile device from a docking port or severing the communications link between the mobile device and the vehicle computation hub 110 and/or the ECU 120. If there is no such notification, the process proceeds to step 330.

If there is a notification for disconnecting of a mobile device, the process may de-authorize (375) the disconnected mobile device so it is no longer paired with the computation hub and/or ECU and can no longer participate in the hybrid vehicle telematics system. The vehicle computation hub and/or ECU may also remove references to the computation resources of the disconnected mobile device from its list of available resources. With the mobile device disconnected, the process 300 may continue to perform telematics applications with one or more built-in sensors and with one or more mobile devices that are still connected with the system. If no mobile device is connected with the hybrid telematics system, the process 300 may continue to perform telematics applications with only data from one or more built-in sensors. The process proceeds to step 330.

At step 330, the process receives sensor data from mobile devices that have docked with the vehicle computation hub and/or ECU, whether physically docked at a docking port or wirelessly linked. The process may also (at step 340) receive sensor data from the one or more built-in sensors of the vehicle.

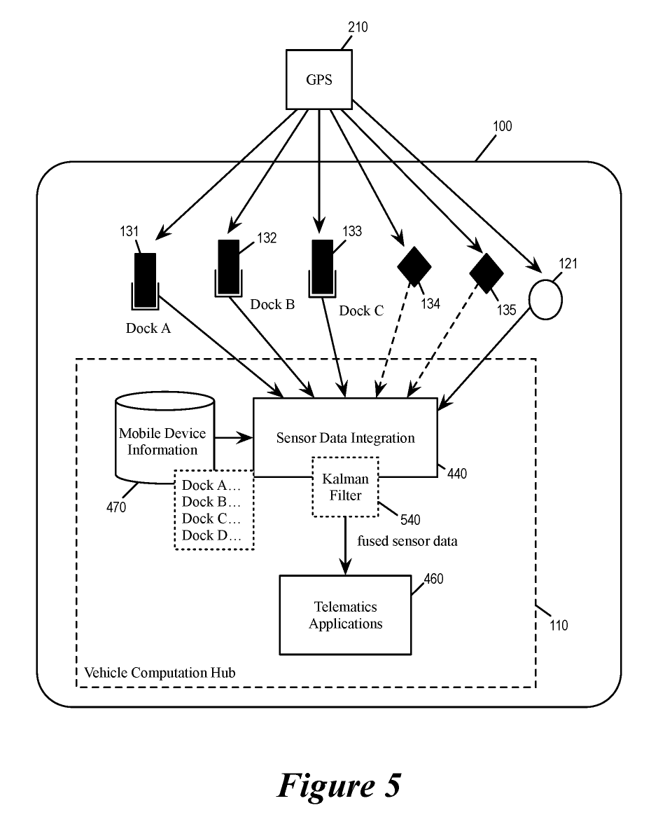

Next, the process performs (at step 350) calculations based on the received data from the docked mobile devices and the one or more built-in sensors to generate output and/or state information for the vehicle's telematics applications. In some embodiments, the process 300 may fuse the received data from the docked mobile devices and the one or more built-in sensors by applying a Kalman filter as described by reference to FIG. 5 below. The process then performs (at step 360) the telematics applications based on the generated output and/or state information. The process then returns to step 320.

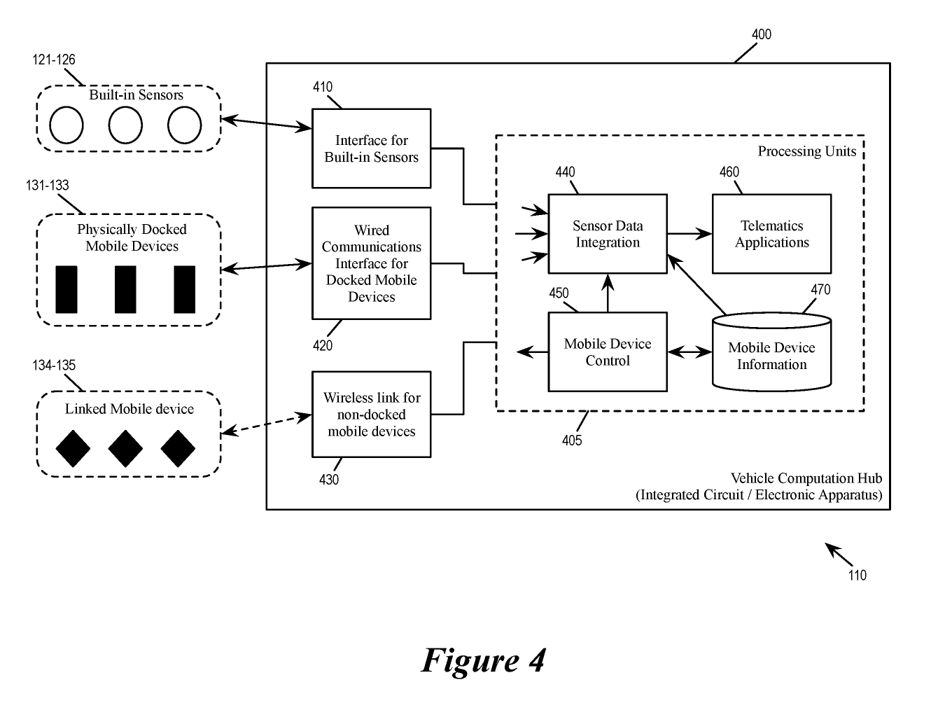

FIG. 4 illustrates a block diagram of the vehicle computation hub 110. In some embodiments, the vehicle computation hub 110 is an electronic apparatus 400 that includes one or more sets of digital circuits, such as integrated circuits (ICs). In some embodiments, the vehicle computation hub is implemented in an IC.

As illustrated, the electronic apparatus 400 may include one or more interfaces 410 for one or more built-in sensors, a wired communications interface 420, and a wireless communications circuit 430. Electronic apparatus 400 may also include a sensor data integration module 440, a mobile device control module 450, a mobile device information storage 470, and a telematics applications module 460. In some embodiments, the sensor data integration module 440, the mobile device control module 450, and the telematics applications module 460 are modules of software whose instructions are executed by one or more processors 405 in the electronic apparatus 400. In some embodiments, the one or more processors 405 execute instructions to perform the process 300.

In some embodiments, the sensor data integration module 440, the mobile device control module 450, and the telematics applications module 460 are each a set of discrete circuits in the electronic apparatus 400 capable of performing their respective functions.

The one or more sensor interfaces 410 may include a set of analog, digital, or mixed signal circuits for sending signals to and receiving signals from the one or more various built-in sensors of the vehicle. Each of the one or more sensor interfaces 410 may communicate with its corresponding built-in sensor through its own communications protocol. The wired communications interface 420 may include a set of analog, digital, or mixed signal circuits for sending signals to and receiving signals from mobile devices through the in-vehicle bus 150 (for communicating with physically docked mobile devices, e.g., 131-133). In some embodiments, the in-vehicle bus supports Ethernet protocol for communicating with mobile devices that are physically docked with the docking ports of the in-vehicle bus 150. The wireless link 430 may include a set of analog, digital, or mixed signal circuits for conducting wireless communications with mobile devices that are not physically docked with the in-vehicle bus but are instead wireless linked with the vehicle computation hub 110 (e.g., mobile devices 134-135).

The sensor data integration module 440 is a module capable of integrating sensor data from the one or more built-in sensors and the one or more mobile devices docked (physically and/or wirelessly) with the vehicle computation hub 110. It may perform various processing algorithms to the received sensor data and produce a set of integrated data for the telematics applications module 460.

The mobile device control module 450 is a module capable of communicating and controlling the one or more mobile devices that have docked with the vehicle computation hub 110. When a mobile device is docked, the mobile device control module 450 receives information regarding the capabilities of the mobile device and store the information in the mobile device information storage 470. Such information for a mobile device may include information regarding the mobile device's CPU and/or GPU performance metric, storage capacity, Internet access bandwidth, peer-to-peer communications capability, GPS capability, voice recognition capability, graphics capability, gyroscope, magnetometer, accelerometer, or other information regarding the sensory, computing and networking resources of the mobile device. Depending on which telematics application is being performed, the mobile device control module 450 may use the information stored in the mobile device information storage 470 to decide which task to assign to which mobile device, which sensor data to collect from which mobile device, and what control information to give to which mobile device. However, in some embodiments, the information regarding the capabilities of the mobile device may not be stored in the storage 470; the information regarding the capabilities of the mobile device may be stored in cloud; or the mobile device control module 450 may query the one or more mobile devices about the information regarding the capabilities when a task is to be dispatched.

The telematics applications module 460 is capable of performing telematics applications such as GPS navigation, integrated hands-free cell phones, wireless safety communications, emergency warning systems, advance driver assistance systems (ADAS), or other telematics applications operating at the vehicle. It may use the integrated data provided by the sensor data integration module 440 to operate telematics applications (GPS, ADAS and the like). In some embodiments, the telematics application module 460 may be connected to a display device of the vehicle to graphically display telematics information for various telematics applications.

In some embodiments, upon receiving signals from one or more mobile devices, the hybrid vehicle telematics system may perform sensor fusing to achieve better SNR and to remove certain systematic biases by applying a Kalman filter. FIG. 5 illustrates the hybrid vehicle telematics system improving sensor data accuracy and SNR by fusing sensor data from one or mobile devices with sensor data from one or more built-in sensors of the vehicle. As illustrated, the vehicle computation hub 110 receives sensor data (e.g., GPS data) from mobile devices 131-135 as well as from built-in sensor 121. The sensor data integration module 440 fuses the sensor data from several sources into one fused sensor data by using a Kalman filter 540.

Kalman filter, also known as linear quadratic estimation (LQE), is an algorithm that uses an array or series of measurements observed over different spatial positions and/or different times to produce estimates of unknown variables that tend to be more precise than those based on a single measurement alone, as each individual measurement may contain statistical noise and other inaccuracies. The Kalman filter may take the form of X_{fused}=X₁+K*(X₂−X₁), where K is Kalman gain, X_{fused} is the resulting fused measurement, and X₁ and X₂ are two measurements from two different sensors. (The two measurements can be two sets of GPS sensor data obtained by a mobile device and by a built-in GPS sensor). X₁ can also be a prediction (from previous data) and X₂ can be a new measurement. This can be extended to N-sensors (N measurements) and estimates (dynamic models/theory). Kalman gain is set to a value between 0 and 1 so the value of X_{fused} is between X₁ and X₂.

In some embodiments, the hybrid vehicle telematics system may use GPS signals from one or more mobile devices aboard the vehicle to improve system GPS accuracy and signal to noise ratio (SNR). Specifically, the system improves GPS accuracy and SNR by using sensor data gathered at different positions or by combining signals from different antennas. Certain antenna positions (of the mobile devices) maybe better at receiving signals than the built-in vehicle antennas.

FIG. 5 also illustrates the hybrid vehicle telematics system improving GPS accuracy and SNR by using sensor data gathered at different positions and from different antennas. As illustrated, the mobile devices 131-135 and the built-in sensor 121 are devices with antennas for receiving GPS data. These devices are at different positions of the vehicle, so their antennas are also at different positions of the vehicle. The mobile devices 131-133 are physically docked at docking ports of the vehicle and their exact positions are known to the vehicle computation hub 110. In some embodiments, the sensor data integration module 440 may take the exact positions of the docking ports into account when fusing the GPS data collected from the different antennas. In some embodiments, the hybrid vehicle telematics system improves sensor signal accuracy and SNR by synchronizing multiple GPS receiving antennas from multiple different sensors as an antenna phased array.

The hybrid vehicle telematics system in some embodiments improves GPS accuracy by incorporating additional GPS signals from one or more mobile devices capable of receiving foreign satellite signals (e.g., based on Russian GLONASS system or Chinese BEIDOU systems). The system may also improve GPS accuracy by incorporating GPS data from A-GPS systems over the Internet accessed by one or more mobile devices.

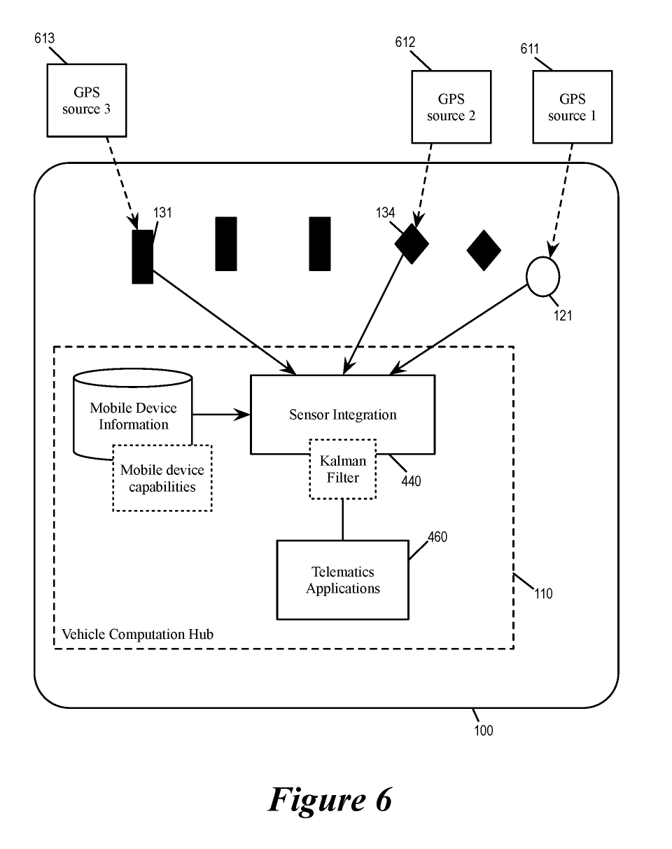

FIG. 6 illustrates the hybrid vehicle telematics system improving GPS accuracy by incorporating additional GPS signals from different GPS sources received by mobile devices. The mobile devices are connected or linked with the vehicle computation hub and/or the ECU and can be physically docked or not. As illustrated, the built-in sensor 121 is receiving GPS signal from GPS source 611, the mobile device 134 is receiving GPS signal from GPS source 612, and the mobile device 131 is receiving GPS signal from GPS source 613. The GPS sources 611, 612, and 613 are sources of different GPS systems employing different sets of satellite or different communications protocols (e.g., BEIDOU or GLONASS systems). In some embodiments, the vehicle computation hub 110 may fuse the signals from the different GPS systems into one fused GPS signal by applying Kalman filter. In some embodiments, the vehicle computation hub 110 may use the GPS source 611 as its primary source of GPS data, i.e., the telematics applications module would primarily use data from GPS source 611 and switch to GPS source 612 or 613 only when GPS source 611 has failed.

In some embodiments, the hybrid vehicle telematics system may identify tasks that are better handled by a particular mobile device and dispatch those tasks to be handled by that mobile device (such as voice recognition and/or actions resulted from the voice recognition). In some embodiments, the hybrid vehicle telematics system may use CPUs and/or GPUs in one or more mobile devices as distributed and/or parallel computing resources and dispatch different tasks to be performed by the different mobile devices.

Computationally, mobile devices such as smartphones generally have very high computational capacity as well as image processing capability. Thus, passing the data to the one or more mobile devices to offload computational or image processing tasks in a distributed manner not only improves accuracy of measurement, but also provides complimentary processing. For example, a dash-mounted front facing camera can record a camera-sensor stream from front of the vehicle, while side or back facing camera sensor streams can be dispatched to a smartphone running a software algorithm to calculate perspective, distance and other aspects of the 3-dimensional environment. The computational burden for such front and back facing visuals can be shared among the CPUs and GPUs of the mobile devices connected with the vehicle computation hub and/or the ECU. Pattern matching tasks can also be shared, as if the entire hybrid telematics system is performing parallel computation.

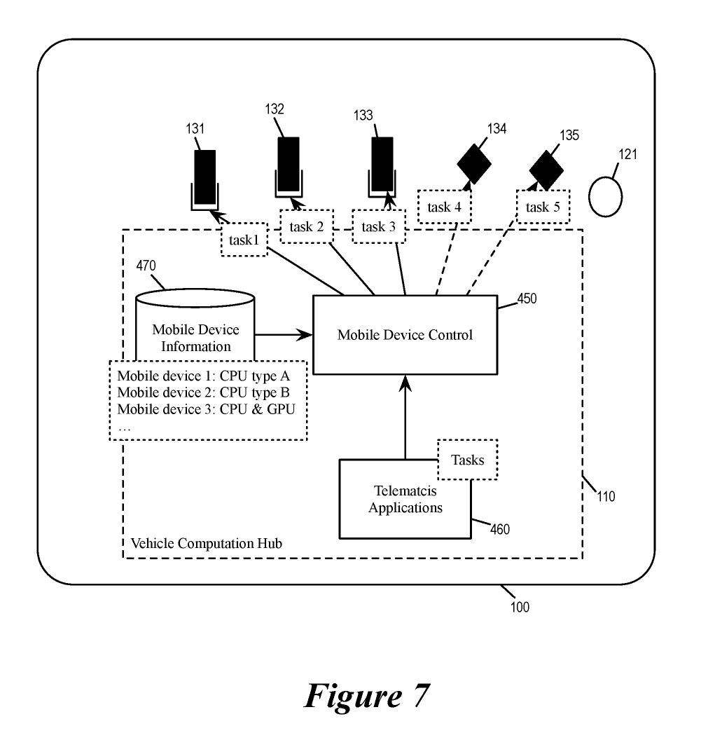

FIG. 7 illustrates the hybrid vehicle telematics system dispatching tasks to the one or more mobile devices docked into the vehicle computation hub 110. The telematics applications module 460 may be running one or more telematics apps that require an array of tasks to be completed. The mobile device control module 450 may identify those tasks and distribute them to the mobile devices 131-135 to be executed.

The mobile device control module 450 queries the mobile device information storage 470 for information regarding the available computing resources in each mobile device. The mobile device control module 450 may then identify a mobile device for each task based on the nature of the task, the capabilities of the computing resources in the mobile device, and the current workload at the mobile device.

For example, in some embodiments, the computation hub 110 would identify the fastest or the idlest CPU among the one or more mobile devices to handle the most computation intensive tasks. In some embodiments, the vehicle computation hub may identify resources in the mobile devices by examining the information stored in the mobile device information storage 470.

In some embodiments, the mobile device information may also indicate which mobile devices are physically docked at a docking port, and therefore may have faster connection with the vehicle computation hub 110 than those that are merely linked. In this case, the mobile devices 131-133 are physically docked so that the mobile device control module 450 may dispatch tasks that require more data traffic with the computation hub to mobile devices 131-133 rather than to mobile devices 134-135.

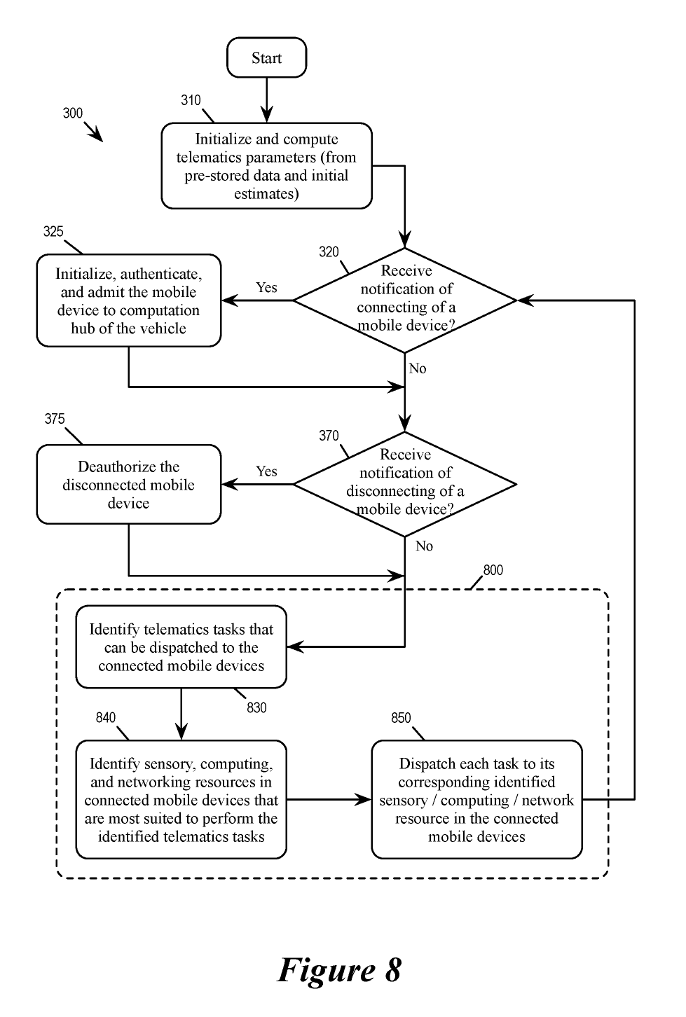

FIG. 8 conceptually illustrates a process 800 for dispatching tasks to one or more mobile devices in a hybrid vehicle telematics system. In some embodiments, the vehicle computation hub 110 performs the process 800 when it is performing its telematics applications. In some embodiments, one or more processors (e.g., processor(s) 405) of a computing device or electronic apparatus (e.g., the apparatus 400) serving as the vehicle computation hub may perform the process 800. In some embodiments, the process 800 is part of the process 300, i.e., it is part of a process performed by the vehicle computation hub to provide telematics applications by fusing signals from one or more mobile devices and by dispatching telematics tasks to one or more mobile devices.

The process 800 starts when at least one mobile device has docked with the vehicle computation hub 110 and has provided information regarding its sensory, computing, and networking resources to the hybrid vehicle telematics system. As illustrated, the process 800 may start after the step 370 of the process 300, in which the process 300 has performed docking and de-docking of mobile devices and has exchanged information with one or more mobile devices.

The process 800 starts when it identifies (at step 830) telematics tasks that can be dispatched to one or more of the mobile devices connected to the vehicle computation hub and/or the ECU. As mentioned, certain telematics tasks, such as image processing can be parceled off and dispatched to faster, newer computing resources in mobile devices. The process may also identify (at step 840) sensory, computing, and networking resources in one or more connected mobile devices that are the most suitable to perform the identified telematics tasks.

The process then dispatches (at 850) each identified telematics task to its corresponding identified sensory, computing or networking resource in the connected mobile devices. In some embodiments, the process may dispatch each task to its assigned mobile device by sending the requisite data and instructions over the in-vehicle bus 150 or the wireless link. The process then returns to 320.

In some embodiments, the hybrid vehicle telematics system may use CPUs of the mobile devices to process and provide some of the data requested by the automobile. Specifically, the CPUs or GPUs of the mobile devices are configured to perform machine-learning inference for the automobile's built-in systems so those built-in systems of the vehicle do not have to access the cloud for the requested data. This configuration may create a computing layer between the vehicle and the cloud. It also provides privacy and reduces access latency.

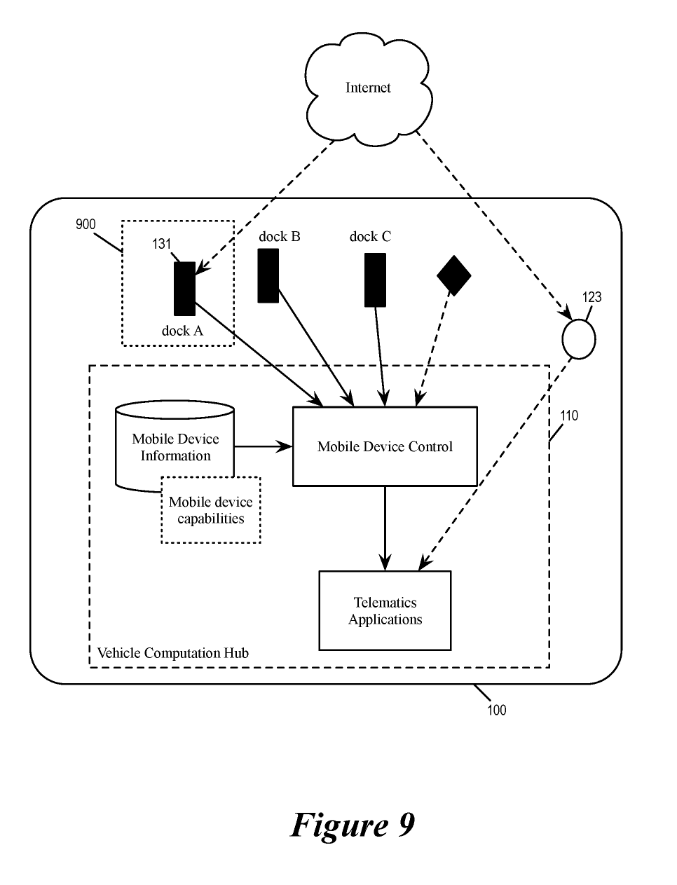

FIG. 9 illustrates the hybrid vehicle telematics system using the computing resources of the one or more mobile devices to create a computing layer between the cloud and the vehicle's built-in systems. As illustrated, the hybrid vehicle telematics system has configured the mobile device 131 to perform machine-learning inference and set up a computing layer 900 between the Internet and the one or more built-in systems of the vehicle. The mobile device 131 learns information from the Internet and stores the learned information like a cache storage. The telematics application module 460 is running an application that normally uses the built-in sensor 123 to obtain information from the Internet (e.g., through cellular networks). However, the computing layer 900 established at the mobile device 131 allows the telematics application module 460 to obtain the same data from the mobile device 131 without using the built-in sensor 123 to access the Internet.

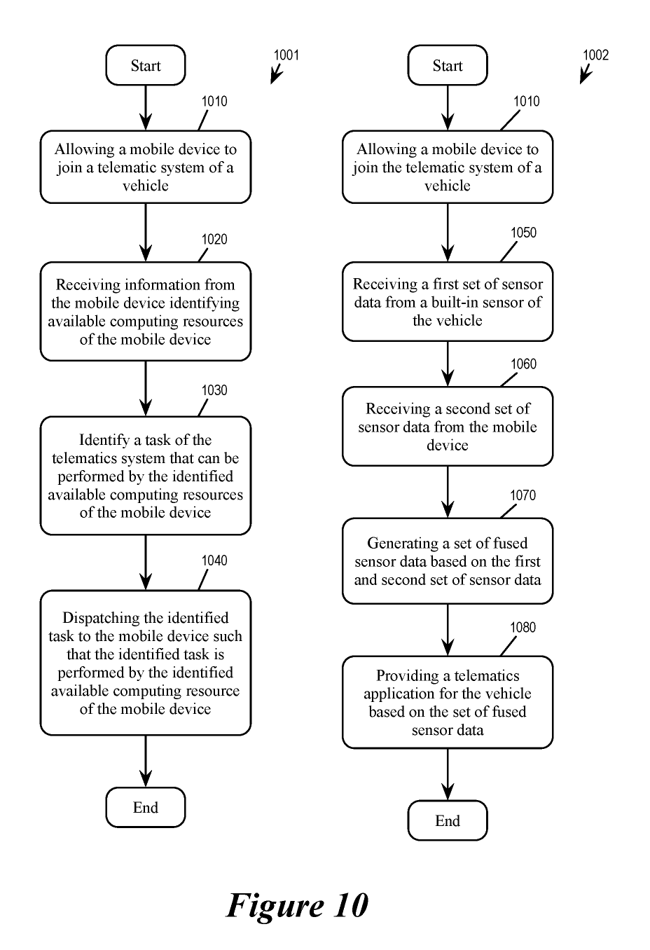

FIG. 10 conceptually illustrates processes 1001 and 1002 for operating a hybrid telematics system in accordance with the present disclosure. In some embodiments, the vehicle computation hub 110 and/or ECU 120 perform both processes 1001 and 1002 when it is performing its telematics applications. In some embodiments, one or more processors (e.g., processor(s) 405) of a computing device or electronic apparatus (e.g., the apparatus 400) serving as the vehicle computation hub and/or ECU performs the processes 1001 and 1002. In some embodiments, the vehicle computation hub and/or ECU performs the processes 1001 and 1002 by performing the steps in the processes 300 and 800 described above by reference to FIGS. 3 and 8.

The process 1001 may be for dispatching tasks to one or more mobile devices that are docked with the hybrid telematics system such that the dispatched tasks are performed by the computing resources available in the one or more mobile devices. The process 1001 starts by allowing (at step 1010) a mobile device to join the telematics system of the vehicle. In some embodiments, the process 1001 allows the mobile device to join the telematics system by performing the steps 310, 320 and 325 of the process 300 in order to receive notification of the docking of the mobile device and to initialize, authenticate, and admit the mobile device to the computation hub and/or ECU of the vehicle. The process 1001 also receives (at step 1020) information from the mobile device identifying available computing resources of the mobile device.

The process 1001 identifies (at 1030) a task of the telematics system that can be performed by the identified available computing resources of the one or more mobile devices. The process 1001 then dispatches (at 1040) the identified task to the mobile device such that the identified task is performed by the identified available computing resource of the mobile device. In some embodiments, the process 1001 identifies and dispatches the task by performing the steps 840 and 850 of the process 800. The process 1001 then ends.

In some embodiments, the vehicle may include one or more built-in sensors, and the telematics system may operate a telematics application based on data from the one or more built-in sensors.

In some embodiments, the identified task may include voice recognition as well as actions or commands triggered by the voice recognition.

In some embodiments, the process 1001 may communicate with the mobile device through a wireless connection, a wired connection through a cable in the vehicle, or a docking port that is a fixture of the vehicle.

In some embodiments, in allowing the mobile device to join the telematics system, process 1001 may authenticate a certificate stored at the mobile device.

In some embodiments, the identified computing resource may include a graphical processing unit (GPU) capable of performing image processing, and the identified task may include an image-processing task.

In some embodiments, the mobile device is a first mobile device and the task is a first task. In such cases, process 1001 may allow a second mobile device to join the telematics system. Process 1001 may also receive information from the second mobile device identifying an available computing resource of the second mobile device. Process 1001 may further identify a second task of the telematics system that can be performed by the identified available computing resource of the second mobile device. Process 1001 may additionally dispatch the second identified task to the second mobile device such that the second task is performed by the identified available computing resource of the second mobile device in parallel with first identified task.

The process 1002 fuses sensor data collected from the one or more built-in sensors and the one or more mobile devices for telematics applications. The process 1002 starts by allowing (at step 1010) a mobile device to join the telematics system of the vehicle. The process then receives (at step 1050) a first set of sensor data from a built-in sensor of the vehicle and receives (at step 1060) a second set of sensor data from the mobile device.

Next, the process 1002 generates (at step 1070) a set of fused sensor data based on the first and second set of sensor data. In some embodiments, the process 1002 may fuse the first and second set of sensor data by applying a Kalman filter as described by reference to FIG. 5 above. The process 1002 provides (at step 1080) a telematics application (e.g., ADAS and navigation) for the vehicle based on the set of fused sensor data. The process 1002 then ends.

In some embodiments, the first set of sensor data includes GPS data.

In some embodiments, in generating the set of fused sensor data based on the first and second sets of sensor data, process 1002 may apply a Kalman filter.

In some embodiments, the first and second sets of sensor data include GPS data from different GPS systems.

In some embodiments, process 1002 may also communicate with the mobile device through a wired connection and a docking port that is a fixture of the vehicle. In such cases, the mobile device may be physically docked with the docking port.

In some embodiments, the second set of sensor data includes measurement provided by a magnetometer in the mobile device.

In some embodiments, process 1002 may also allow a plurality of mobile devices to join the telematics system and synchronizing the plurality of mobile devices to form an antenna phased array.

### Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

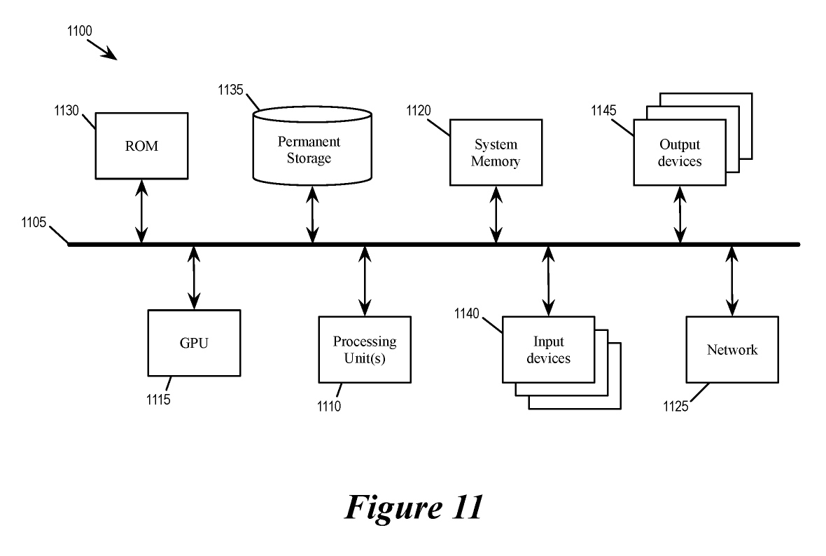

FIG. 11 conceptually illustrates an electronic system 1100 with which some embodiments of the present disclosure are implemented. The electronic system 1100 may be a computer (e.g., a desktop computer, personal computer, tablet computer, etc.), phone, PDA, or any other sort of electronic device. Such an electronic system may include various types of computer readable media and interfaces for various other types of computer readable media. Electronic system 1100 includes a bus 1105, processing unit(s) 1110 (e.g., processor(s) such as CPU(s)), a graphics-processing unit (GPU) 1115, a system memory 1120, a network 1125, a read-only memory 1130, a permanent storage device 1135, input devices 1140, and output devices 1145.

The bus 1105 may collectively represent all system, peripheral, and chipset buses that communicatively connect the numerous internal devices of the electronic system 1100. For instance, the bus 1105 communicatively connects the processing unit(s) 1110 with the GPU 1115, the read-only memory 1130, the system memory 1120, and the permanent storage device 1135.

From these various memory units, the processing unit(s) 1110 may retrieve instructions to execute and data to process in order to execute the processes of the present disclosure. The processing unit(s) may be a single processor or a multi-core processor in different embodiments. Some instructions may be passed to and executed by the GPU 1115. The GPU 1115 can offload various computations or complement the image processing provided by the processing unit(s) 1110.

The read-only-memory (ROM) 1130 stores static data and instructions that are needed by the processing unit(s) 1110 and other modules of the electronic system. The permanent storage device 1135, on the other hand, is a read-and-write memory device. This device is a non-volatile memory unit that stores instructions and data even when the electronic system 1100 is off. Some embodiments of the present disclosure use a mass-storage device (such as a magnetic or optical disk and its corresponding disk drive) as the permanent storage device 1135.

Other embodiments use a removable storage device (such as a floppy disk, flash memory device, etc., and its corresponding disk drive) as the permanent storage device. Like the permanent storage device 1135, the system memory 1120 is a read-and-write memory device. However, unlike storage device 1135, the system memory 1120 is a volatile read-and-write memory, such a random access memory. The system memory 1120 stores some of the instructions and data that the processor needs at runtime. In some embodiments, processes in accordance with the present disclosure are stored in the system memory 1120, the permanent storage device 1135, and/or the read-only memory 1130. For example, the various memory units include instructions for processing multimedia clips in accordance with some embodiments. From these various memory units, the processing unit(s) 1110 retrieves instructions to execute and data to process in order to execute the processes of some embodiments.

The bus 1105 also connects to the input and output devices 1140 and 1145. The input devices 1140 enable the user to communicate information and select commands to the electronic system. The input devices 1140 may include alphanumeric keyboards and pointing devices (also called “cursor control devices”), cameras (e.g., webcams), microphones or similar devices for receiving voice commands, etc. The output devices 1145 may display images generated by the electronic system or otherwise output data. The output devices 1145 may include printers and display devices, such as cathode ray tubes (CRT) or liquid crystal displays (LCD), as well as speakers or similar audio output devices. Some embodiments may include devices such as a touchscreen that function as both input and output devices.

Finally, as shown in FIG. 11, bus 1105 also couples electronic system 1100 to a network 1125 through a network adapter (not shown). In this manner, the computer can be a part of a network of computers (such as a local area network (“LAN”), a wide area network (“WAN”), or an Intranet, or a network of networks, such as the Internet. Any or all components of electronic system 1100 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIGS. 3, 8, and 10) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
identifying an available computing resource of a mobile device;
identifying a task of a telematics system that can be performed by the identified available computing resource of the mobile device; and
dispatching the identified task to the mobile device such that the identified task is performed by the identified available computing resource of the mobile device.

2. The method of claim 1, wherein the vehicle comprises one or more built-in sensors, and where the telematics system operates a telematics application based on data from the one or more built-in sensors.

3. The method of claim 1, wherein the identified task comprises voice recognition.

4. The method of claim 1 further comprising:
communicating with the mobile device through a wired connection and a docking port that is a fixture of the vehicle.

5. The method of claim 1, wherein allowing the mobile device to join the telematics system comprises authenticating a certificate stored at the mobile device.

6. The method of claim 1, wherein the identified computing resource comprises a graphical processing unit (GPU) capable of performing image processing, and wherein the identified task comprises an image-processing task.

7. The method of claim 1, wherein the mobile device is a first mobile device and the task is a first task, and wherein the method further comprises:
allowing a second mobile device to join the telematics system;
identifying an available computing resource of the second mobile device;
identifying a second task of the telematics system that can be performed by the identified available computing resource of the second mobile device; and
dispatching the second identified task to the second mobile device such that the second task is performed by the identified available computing resource of the second mobile device in parallel with first identified task.

8. A method, comprising:
allowing a mobile device to join a telematics system of a vehicle;
receiving a first set of sensor data from a built-in sensor of the vehicle and a second set of sensor data from the mobile device;
generating a set of fused sensor data based on the first and second sets of sensor data; and
providing a telematics application for the vehicle based on the set of fused sensor data.

9. The method of claim 8, wherein the first set of sensor data comprises global positioning system (GPS) data.

10. The method of claim 8, wherein generating the set of fused sensor data based on the first and second sets of sensor data comprises applying a Kalman filter.

11. The method of claim 8, wherein the first and second sets of sensor data comprise global positioning system (GPS) data from different GPS systems.

12. The method of claim 8 further comprising:
communicating with the mobile device through a wired connection and a docking port that is a fixture of the vehicle,
wherein the mobile device is physically docked with the docking port.

13. The method of claim 12, wherein the second set of sensor data comprises measurement provided by a magnetometer in the mobile device.

14. The method of claim 8 further comprising:
allowing a plurality of mobile devices to join the telematics system and synchronizing the plurality of mobile devices to form an antenna phased array.

15. An electronic apparatus, comprising:
a wired communications interface capable of communicating with at least a first mobile device through a wired communications medium;
a sensor interface capable of receiving data from one or more built-in sensors of a vehicle; and
one or more processors capable of providing telematics applications for the vehicle by dispatching one or more tasks to be performed at computing resources of the first mobile device over the wired communications interface and by fusing sensor data provided by the first mobile device with sensor data provided by the one or more built-in sensors.

16. The apparatus of claim 15, wherein the wired communications medium comprises one or more docking ports that are fixtures of the vehicle and the first mobile device is physically docked at one of the docking ports.

17. The apparatus of claim 15 further comprising:
a wireless communications interface capable of communicating with at least a second mobile device through a wireless communications medium,
wherein the one or more processors are further capable of dispatching one or more tasks to the second mobile device.

18. The apparatus of claim 15, wherein the one or more processors are capable of assigning the first mobile device a L2 MAC address to communicate over the wired communications medium.

19. The apparatus of claim 15, wherein the one or more processors are further capable of performing actions comprising:
allowing the first mobile device to communicatively connect to the one or more processors;
identifying an available computing resource of the first mobile device;
identifying a task that can be performed by the identified available computing resource of the first mobile device; and
dispatching the identified task to the first mobile device such that the identified task is performed by the identified available computing resource of the first mobile device.

20. The apparatus of claim 19, wherein the identified computing resources of the first mobile device comprises a graphical processing unit (GPU) capable of performing image processing, and wherein the one or more processors are further capable of dispatching one or more image processing tasks to the first mobile device.
